(19) United States
(12) Patent Application Publication
(10) Pub. No.: US 2025/0184036 A1
(43) Pub. Date: Jun. 5, 2025

(54) METHOD AND APPARATUS FOR ROBUST COMMUNICATION IN UNMANNED AERIAL VEHICLE COMMUNICATION SYSTEMS WITH UAV JITTERING

(71) Applicant: Electronics and Telecommunications Research Institute, Daejeon (KR)

(72) Inventors: Hoondong NOH, Daejeon (KR); Dukhyun YOU, Daejeon (KR); Kyuyeon LEE, Seoul (KR); Kwangmyeong YANG, Seoul (KR); Jieun YU, Seoul (KR); Chungyong LEE, Seoul (KR); Hyungje LEE, Seoul (KR)

(21) Appl. No.: 18/963,418

(22) Filed: Nov. 27, 2024

(30) Foreign Application Priority Data
Dec. 1, 2023 (KR) 10-2023-0172836
Oct. 22, 2024 (KR) 10-2024-0145256

(51) Int. Cl. H04L 1/00; B64U 40/20; H04L 43/087

(52) U.S. Cl. CPC H04L 1/0042; B64U 40/20; H04L 43/087; B64U 2201/20

(57) ABSTRACT

A method for performing unmanned aerial vehicle (UAV) jitter-resistant communication in a communication system using a UAV, performed by a UAV node, may comprise: acquiring UAV jitter information for the UAV node; and determining a UAV transmission and reception technique based on the UAV jitter information, wherein the UAV transmission and reception technique includes determination or configuration of a beamformer or a codebook to perform signal transmission and reception robust against a UAV jitter between the UAV node and a counterpart node.

### CROSS-REFERENCE TO RELATED APPLICATIONS

This application claims priority to Korean Patent Applications No. 10-2023-0172836, filed on Dec. 1, 2023, and No. 10-2024-0145256, filed on Oct. 22, 2024, with the Korean Intellectual Property Office (KIPO), the entire contents of which are hereby incorporated by reference.

### BACKGROUND

### 1. Technical Field

The present disclosure relates to a wireless communication system, and more particularly, to a technique for coping with performance degradation caused by a unmanned aerial vehicle (UAV) jitter in a communication system using UAVs.

### 2. Related Art

In wireless communication systems using unmanned aerial vehicles (UAVs), when a UAV node is equipped with a multi-antenna array, beamforming technology is typically used to generate directional beams to overcome path attenuation and improve the quality of transmitted and received signals over long distances.

When the UAV node operates as a transmitting node in the communication system, acquiring accurate angle-of-departure (AoD) information affects the quality of transmitted and received signals. Conversely, when it operates as a receiving node, acquiring accurate angle-of-arrival (AoA) information affects the quality of transmitted and received signals.

However, due to the characteristics of UAVs, unintended sudden changes in the body's azimuth angle may occur, caused by factors such as vibrations from internal motors and external weather phenomena such as sudden gusts. These changes may lead to estimation errors in the AoA or AoD in the operation of transmitting and receiving nodes mounted on the UAV within the wireless communication system.

Meanwhile, in a wireless communication system that supports UAVs using terrestrial base stations, it is possible to approximate a probability distribution of AoA estimation errors by utilizing a positional relationship between the UAV and the terrestrial base station and orientation information of the UAV. However, such random AoA estimation errors may cause variation in a channel gain of a link between the terrestrial station and the UAV over time.

The aforementioned AoA or AoD change in the UAV node caused by body disturbance may be referred to as UAV jitter or UAV jittering effect. This jittering effect significantly degrades the performance of UAV millimeter-wave communication, necessitating solutions to mitigate these effects.

### SUMMARY

An objective of the present disclosure is to provide a communication method and apparatus capable of addressing AoA or AoD estimation errors due to UAV jittering.

Another objective of the present disclosure is to provide a communication method and apparatus that operate robustly against a UAV jitter by utilizing associated signaling and network operation techniques for managing a transmission and reception technique for a UAV node.

Yet another objective of the present disclosure is to provide a robust communication method and apparatus for a UAV node, which are capable of managing a UAV jitter in various network node configurations, including uplink or downlink signals between a base station and a UAV node or sidelink signals between UAV nodes.

According to a first exemplary embodiment of the present disclosure, a method for performing unmanned aerial vehicle (UAV) jitter-resistant communication in a communication system using a UAV, performed by a UAV node, may comprise: acquiring UAV jitter information for the UAV node; and determining a UAV transmission and reception technique based on the UAV jitter information, wherein the UAV transmission and reception technique may include determination or configuration of a beamformer or a codebook to perform signal transmission and reception robust against a UAV jitter between the UAV node and a counterpart node.

The acquiring of the UAV jitter information may comprise: receiving a jitter reference signal from the counterpart node; calculating a mean and variance of each azimuth angle measured by an embedded sensor device of the UAV node; and obtaining the UAV jitter information based on a unit vector derived from the jitter reference signal and the calculated mean and variance.

The jitter reference signal may include information on an index of a transmission (Tx) beam operated by the counterpart node, which is a terrestrial base station, and include information related to an angle of departure (AoD) from the counterpart node.

The acquiring of the UAV jitter information may comprise: receiving pilot signals from the counterpart node; calculating a mean and variance for each azimuth angle measured by an embedded sensor device of the UAV node; and obtaining the UAV jitter information based on the mean and variance and information on angles of arrival (AoAs) calculated from information derived from the pilot signals.

The method may further comprise: transmitting the UAV jitter information to the counterpart node; and receiving information on a reception beamformer for the UAV node from the counterpart node, the reception beamformer being determined by the counterpart node based on the UAV jitter information.

The method may further comprise: transmitting the UAV jitter information to the counterpart node; and receiving information on a reception beam codebook for the UAV node from the counterpart node, the reception beam codebook being determined by the counterpart node based on the UAV jitter information.

According to a second exemplary embodiment of the present disclosure, a method for performing unmanned aerial vehicle (UAV) jitter-resistant communication in a communication system using a UAV, performed by a UAV node, may comprise: transmitting a jitter reference signal to a counterpart node, the jitter reference signal including information on a change in an azimuth angle measured by an embedded sensor device of the UAV node; receiving, from the counterpart node, UAV jitter information obtained by utilizing the jitter reference signal and a unit vector calculated by the counterpart node; and determining a reception beamformer based on the UAV jitter information.

The jitter reference signal may include information on a change in an azimuth angle of the UAV node, angle of arrival (AoA) information of the UAV node, and information on a relative positional relationship from the counterpart node to the UAV node.

The unit vector may include information related to an angle of departure (AoD) of a signal from the UAV node, based on a transmission beam index of the UAV node.

According to a third exemplary embodiment of the present disclosure, a method for performing unmanned aerial vehicle (UAV) jitter-resistant communication in a communication system utilizing a UAV node, performed by a UAV node, may comprise: transmitting a jitter reference signal to a counterpart node, the jitter reference signal including information on an azimuth angle measured by an embedded sensor device of the UAV node; and receiving information on a reception beam codebook from the counterpart node, wherein the information on the reception beam codebook includes information on a codebook determined by the counterpart node based on UAV jitter information obtained using the jitter reference signal and a unit vector calculated by the counterpart node.

The jitter reference signal may include information on a change in an azimuth angle of the UAV node, angle of arrival (AoA) information of the UAV node, and information on a relative positional relationship from the counterpart node to the UAV node.

The unit vector may include information related to an angle of departure (AoD) of a signal from the UAV node, based on a transmission beam index of the UAV node.

According to a fourth exemplary embodiment of the present disclosure, an apparatus for performing unmanned aerial vehicle (UAV) jitter-resistant communication in a communication system using a UAV node may comprise: a memory storing at least one command; and a processor connected to the memory to execute the at least one command, wherein the at least one command may cause the processor to: acquire UAV jitter information for the UAV node; and determine a UAV transmission and reception technique based on the UAV jitter information, wherein the UAV transmission and reception technique may include determination or configuration of a beamformer or codebook to perform signal transmission and reception robust against a UAV jitter between the UAV node and a counterpart node which is a terrestrial base station or another UAV node.

In the acquiring of the UAV jitter information, the at least one command may cause the processor to: receive a jitter reference signal from the counterpart node; calculate a mean and variance for each azimuth angle measured by an embedded sensor device of the UAV node; and obtain the UAV jitter information based on a unit vector derived from the jitter reference signal and the calculated mean and variance.

The jitter reference signal may include information on an index of a transmission (Tx) beam operated by the counterpart node, which is a terrestrial base station, and include information related to an angle of departure (AoD) from the counterpart node.

In the acquiring of the UAV jitter information, the at least one command may cause the processor to: receive pilot signals from the counterpart node; calculate a mean and variance for each azimuth angle measured by an embedded sensor device of the UAV node; and obtain the UAV jitter information based on the mean and variance and information on angles of arrival (AoAs) calculated from information derived from the pilot signals.

The at least one command may further cause the processor to: transmit the UAV jitter information to the counterpart node, and receive information on a reception beamformer for the UAV node from the counterpart node, the reception beamformer being determined by the counterpart node based on the UAV jitter information.

The at least one command may further cause the processor to: transmit the UAV jitter information to the counterpart node; and receive information on a reception beam codebook for the UAV node from the counterpart node, the reception beam codebook being determined by the counterpart node based on the UAV jitter information.

The information on the reception beam codebook may include information on a codebook determined by the counterpart node based on the UAV jitter information obtained using a jitter reference signal and a unit vector calculated by the counterpart node.

The jitter reference signal may include information on a change in an azimuth angle of the UAV node, angle of arrival (AoA) information of the UAV node, and information on a relative positional relationship from the counterpart node to the UAV node.

According to the present disclosure, a UAV node equipped with a communication device may adopt a method of selecting a transmission and reception technique that is robust against angle-of-arrival (AoA) or angle-of-departure (AoD) estimation errors. That is, in a communication system where an UAV operates as a transmitting and receiving node, issues such as sudden channel gain reduction and unpredictable beam misalignment may arise due to the impact of a UAV jitter caused by a body disturbance of the UAV The UAV jitter may arise from combined effects of various factors, such as a relative positional relationship between the UAV node and a counterpart node, as well as an inherent instability of the UAV node's body. Therefore, in the present disclosure, the UAV node and the counterpart node measure or exchange various types of information to assess a current level of the UAV jitter and acquire relevant UAV jitter information.

Based on these information, the UAV node and/or the counterpart node can determine an appropriate transmission and reception technique, thereby enabling robust communication that is resilient to the UAV jitter. Additionally, according to the configuration of the present disclosure, in various network configurations, the UAV node and the counterpart node can measure or exchange necessary information to acquire the UAV jitter information. Utilizing the UAV jitter information, they can appropriately determine a transmission and reception technique for the UAV node, thereby enabling the operation of the communication system that is resilient to the UAV jitter.

### BRIEF DESCRIPTION OF DRAWINGS

FIG. 1 is a conceptual diagram of a wireless communication network to which a communication method according to exemplary embodiments of the present disclosure is applicable.

FIG. 2A is a conceptual diagram of a non-terrestrial network to which a communication method according to an exemplary embodiment of the present disclosure is applicable.

FIG. 2B is a conceptual diagram of another non-terrestrial network to which a communication method according to an exemplary embodiment of the present disclosure is applicable.

FIG. 3 is a schematic block diagram of an entity constituting a communication network according to an exemplary embodiment of the present disclosure.

FIG. 4 is a schematic diagram of a scenario in which a terrestrial base station supports a UAV terminal in the present exemplary embodiment.

FIG. 5 is an illustrative diagram describing azimuth angle (α,β,γ) information of a UAV node.

FIG. 6 is a signal flow diagram illustrating a case where UAV jitter information is acquired using information from the counterpart node according to the present exemplary embodiment.

FIG. 7 is a signal flow diagram illustrating a case in which UAV jitter information is obtained by utilizing information measured from the counterpart node in the present exemplary embodiment.

FIG. 8 is a signal flow diagram illustrating an exemplary embodiment in which UAV jitter information is obtained using information from a counterpart node, and the counterpart node determines a reception beamformer for a UAV node.

FIG. 9 is a signal flow diagram illustrating an exemplary embodiment in which UAV jitter information is obtained using information measured from a counterpart node, and the counterpart node determines a reception beam codebook for a UAV node.

FIG. 10 is a signal flow diagram illustrating an exemplary embodiment in which UAV jitter information is obtained using information from a UAV node, and the UAV node determines a reception beam codebook for the UAV node.

FIG. 11 is a signal flow diagram illustrating an exemplary embodiment in which UAV jitter information is obtained using information from a UAV node, and a counterpart node determines a reception beam codebook for the UAV node.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), or the like. The 4G communication network and the 5G communication network may be classified as terrestrial networks.

A terrestrial network may be referred to as a wireless communication network and may be used interchangeably with a wireless communication system.

A non-terrestrial network may operate based on LTE technology and/or NR technology. The non-terrestrial network may support communication in a frequency band below 6 GHz as well as in a frequency band above 6 GHz. The 4G communication network may support communication in a frequency band below 6 GHz. The 5G communication network may support communication in frequency bands both below and above 6 GHz.

The communication network to which exemplary embodiments according to the present disclosure are applied is not limited to the contents described below, and exemplary embodiments according to the present disclosure may be applied to various communication networks. Here, a communication network may be used interchangeably with a communication system.

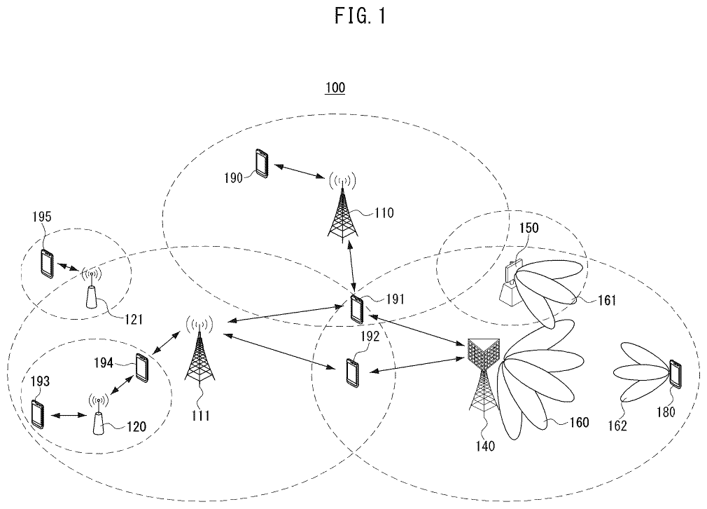

FIG. 1 is a conceptual diagram of a wireless communication network to which a communication method according to exemplary embodiments of the present disclosure is applicable.

Referring to FIG. 1, a wireless communication network 100 may include a plurality of communication nodes 110, 111, 120, 121, 140, 150, 180, 190, 191, 192, 193, 194, and 195. Each of the plurality of communication nodes may support at least one communication protocol. For example, each of the plurality of communication nodes may support a communication protocol based on code division multiple access (CDMA), wideband CDMA (WCDMA), time division multiple access (TDMA), frequency division multiple access (FDMA), orthogonal frequency division multiplexing (OFDM), orthogonal frequency division multiple access (OFDMA), single carrier (SC)-FDMA, non-orthogonal multiple access (NOMA), or space division multiple access (SDMA).

In addition, each of the plurality of communication nodes 110, 111, 120, 121, 140, 150, 180, 190, 191, 192, 193, 194, and 195 may support radio access protocol specifications of radio access technologies based on cellular communications (e.g. LTE, LTE-Advanced, NR, etc.) as defined by the 3rd Generation Partnership Project (3GPP). Each of the plurality of base stations 110, 111, 120, 121, 140, and 150 may operate in a different frequency band or in the same frequency band. The plurality of base stations 110, 111, 120, 121, 140, and 150 may be interconnected via an ideal backhaul or a non-ideal backhaul and may exchange information with each other through the ideal backhaul or the non-ideal backhaul. Each of the plurality of base stations 110, 111, 120, 121, 140, and 150 may also be connected to a core network (not shown) via a backhaul. Each of the plurality of base stations 110, 111, 120, 121, 140, and 150 may transmit data received from the core network to its corresponding terminal 180, 190, 191, 192, 193, 194, or 195 and may transmit data received from the terminal 180, 190, 191, 192, 193, 194, or 195 to the core network.

In addition, each of the plurality of communication nodes 110, 111, 120, 121, 140, 150, 180, 190, 191, 192, 193, 194, and 195 constituting the wireless communication network 100 may exchange signals with counterpart communication nodes without interference by using beams formed through beamforming with multiple antennas.

More specifically, the wireless communication network 100 may include a plurality of base stations (BSs) 110, 111, 120, 121, 140, and 150 and a plurality of terminals (e.g. user equipments (UEs)) 180, 190, 191, 192, 193, 194, and 195. Each of the plurality of base stations 110, 111, and 140 may form a macro cell, and each of the plurality of base stations 120, 121, and 150 may form a small cell. A plurality of terminals 190 and 191 may be located within a cell coverage of the base station 110. A plurality of base stations 120 and 121 and a plurality of terminals 191, 192, 193, and 194 may be located within a cell coverage of the base station 111. The base station 150 and a plurality of terminals 180, 191, and 192 may be located within a cell coverage of the base station 140.

Each of the plurality of base stations 110, 111, 120, 121, 140, and 150 may support multiple input multiple output (MIMO) transmission using multiple antennas (e.g. single-user (SU)-MIMO, multi-user (MU)-MIMO, massive MIMO), coordinated multipoint (CoMP) transmission, carrier aggregation (CA) transmission, unlicensed band transmission, device-to-device (D2D) communication, proximity services (ProSe), dual connectivity (DC) transmission, and/or the like.

Each of the plurality of base stations 110, 111, 120, 121, 140, and 150 may be referred to as a NodeB, evolved NodeB, gNB, ng-eNB, radio base station, access point, access node, node, or radio side unit (RSU).

Each of the plurality of terminals 180, 190, 191, 192, 193, 194, and 195 may be referred to as an unmanned aerial vehicle (UAV), drone, user equipment (UE), terminal, access terminal, mobile terminal, station, subscriber station, mobile station, portable subscriber station, node, device, Internet of Things (IoT) device, mounted device (e.g., mounted module/device/terminal or on-board device/terminal), or the like.

The present disclosure is not limited to the terms mentioned above and the terms may be substituted with other terms indicating entities performing equivalent functions based on a radio access protocol according to a radio access technology (RAT) and functional configurations supporting the RAT.

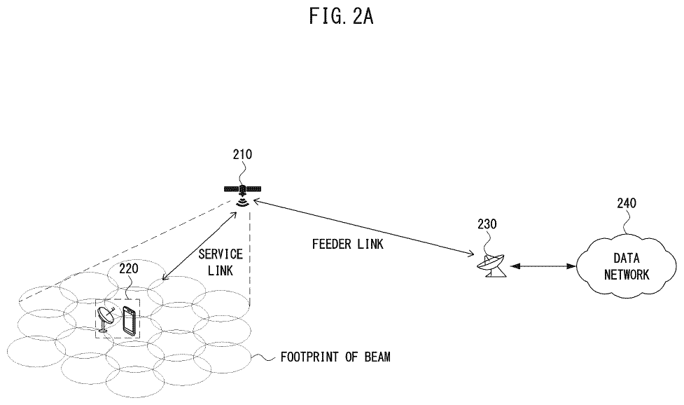

FIG. 2A is a conceptual diagram of a non-terrestrial network to which a communication method according to an exemplary embodiment of the present disclosure is applicable.

Referring to FIG. 2A, a non-terrestrial network (NTN) may include a satellite 210, a communication node 220, a gateway 230, a data network 240, and the like. The NTN shown in FIG. 2A may be an NTN based on a transparent payload. The satellite 210 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 220 may include a communication node (e.g. a user equipment (UE) or a terminal) located on a terrestrial site and a communication node (e.g. an airplane, a drone) located on a non-terrestrial space. A service link may be established between the satellite 210 and the communication node 220, and the service link may be a radio link. The satellite 210 may provide communication services to the communication node 220 using one or more beams. The shape of a footprint of the beam of the satellite 210 may be elliptical.

The communication node 220 may perform communications (e.g. downlink communication and uplink communication) with the satellite 210 using LTE technology and/or NR technology. The communications between the satellite 210 and the communication node 220 may be performed using an NR-Uu interface. When dual connectivity (DC) is supported, the communication node 220 may be connected to other base stations (e.g. base stations supporting LTE and/or NR functionality) as well as the satellite 210, and perform DC operations based on the techniques defined in the LTE and/or NR specifications.

The gateway 230 may be located on a terrestrial site, and a feeder link may be established between the satellite 210 and the gateway 230. The feeder link may be a radio link. The gateway 230 may be referred to as a ‘non-terrestrial network (NTN) gateway’. The communications between the satellite 210 and the gateway 230 may be performed based on an NR-Uu interface or a satellite radio interface (SRI). The gateway 230 may be connected to the data network 240. There may be a ‘core network’ between the gateway 230 and the data network 240. In this case, the gateway 230 may be connected to the core network, and the core network may be connected to the data network 240. The core network may support the NR technology. For example, the core network may include an access and mobility management function (AMF), a user plane function (UPF), a session management function (SMF), and the like. The communications between the gateway 230 and the core network may be performed based on an NG-C/U interface.

In addition, a base station and the core network may exist between the gateway 230 and the data network 240. In this case, the gateway 230 may be connected with the base station, the base station may be connected with the core network, and the core network may be connected with the data network 240. The base station and core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

FIG. 2B is a conceptual diagram of another non-terrestrial network to which a communication method according to an exemplary embodiment of the present disclosure is applicable.

Referring to FIG. 2B, a non-terrestrial network may include a first satellite 211, a second satellite 212, a communication node 220, a gateway 230, a data network 240, and the like. The NTN shown in FIG. 2B may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways) constituting the communication networks, such as the wireless communication network shown in FIG. 1 and the non-terrestrial networks shown in FIGS. 2A and 2B, may be configured as follows.

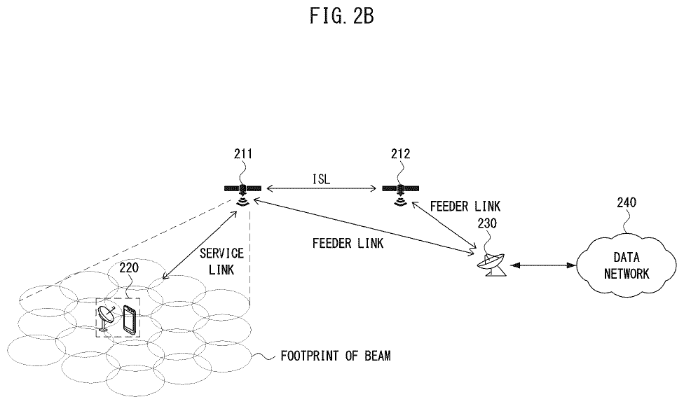

FIG. 3 is a schematic block diagram of an entity constituting a communication network according to an exemplary embodiment of the present disclosure.

Referring to FIG. 3, an entity 300 may comprise at least one processor 310, a memory 320, and a transceiver 330 connected to the network for performing communications. Also, the entity 300 may further comprise an input interface device 340, an output interface device 350, a storage device 360, and the like. The respective components included in the entity 300 may communicate with each other as connected through a bus 370.

However, the respective components included in the entity 300 may be connected not to the common bus 370 but to the processor 310 through an individual interface or an individual bus. For example, the processor 310 may be connected to at least one of the memory 320, the transceiver 330, the input interface device 340, the output interface device 350, and the storage device 360 through dedicated interfaces.

The processor 310 may execute a program stored in at least one of the memory 320 and the storage device 360. The processor 310 may refer to a central processing unit (CPU), a graphics processing unit (GPU), or a dedicated processor on which methods in accordance with embodiments of the present disclosure are performed. Each of the memory 320 and the storage device 360 may be constituted by at least one of a volatile storage medium and a non-volatile storage medium. For example, the memory 320 may comprise at least one of read-only memory (ROM) and random access memory (RAM).

For example, the processor 310 may include a beamforming control unit, a mapper, a generation unit, and a modem, each of which may be configured through software, hardware, or a combination thereof. The processor 310 may transmit signals or receive signals or feedback signals through multiple antennas. The beamforming control unit may reconfigure a signal to adapt transmission data for IFFT transformation, transforming the signal into OFDM signals and signals for multiple antennas. The generation unit may multiply each antenna-specific transmission data output from the mapper by corresponding antenna weights based on determination or configuration of the antenna weights from the beamforming control unit. The modem may perform IFFT on the transmission data, to which the antenna weights have been applied, transforming frequency-domain signals into time-domain signals that may be transmitted through multiple antennas. In this process, the beamforming control unit may determine or configure a beamformer according to the antenna weights, and may determine, configure, or update a codebook, which configures information on a channel. The codebook may include a beamforming codebook.

Additionally, program instructions may include at least one instruction for performing operations or functions of at least one of the aforementioned beamforming control unit, mapper, generation unit, and modem.

The communication device 300 according to the present exemplary embodiment may be used in at least one of an unmanned aerial vehicle (UAV) or a terrestrial base station. The UAV may be referred to as a UAV terminal or UAV node, while the terrestrial base station may be referred to as a counterpart node. The communication device 300 may include a communication controller, controller, or processor mounted on either the UAV node or the counterpart node.

Additionally, the communication device 300 in the present exemplary embodiment may enable the UAV node to determine its own beamformer or to determine a codebook to improve a communication environment with the counterpart node under support of the counterpart node, or it may also allow the counterpart node to determine a beamformer or to determine a codebook.

In the present exemplary embodiment, a codebook may refer to a means designed for zero antenna correlation, where an ideal beamforming matrix is uniformly distributed, or to a means that performs a function equivalent to this purpose. Specifically, a codebook may be an indexed collection of predefined code vectors used for encoding or decoding. In other words, a codebook may refer to a set of code vectors that indexes a sufficiently large variety of patterns for input data. The codebook may include a random codebook, algebraic codebook, and others. By using such a codebook, the entire information may be segmented and each segment represented solely by a codebook index, thereby facilitating encoding of the input data. A quantized codeword matrix (or vector) determined by the codebook may be designed to be uniformly distributed across quantization spaces.

Beamforming, carried out by a beamformer, is a technology that concentrates an antenna beam on a specific terminal and is implemented using multiple antennas in a type of smart antenna system. When multiple antennas are implemented on both the transmitter and receiver, this configuration is referred to as multiple-input multiple-output (MIMO). In long-distance and non-line-of-sight (NLOS) communication, single-user MIMO is typically used, and in such cases, antenna correlation is generally close to zero. On the other hand, antenna correlation may be non-zero in some situations and close to zero in others. For example, multi-user MIMO or spatial division multiple access (SDMA) for downlink works well with small antenna spacing, whereas single-user MIMO may prefer larger antenna spacing.

Hereinafter, a more detailed description will be provided on a robust communication method and apparatus against UAV jitter in a communication system using UAVs according to the present exemplary embodiment.

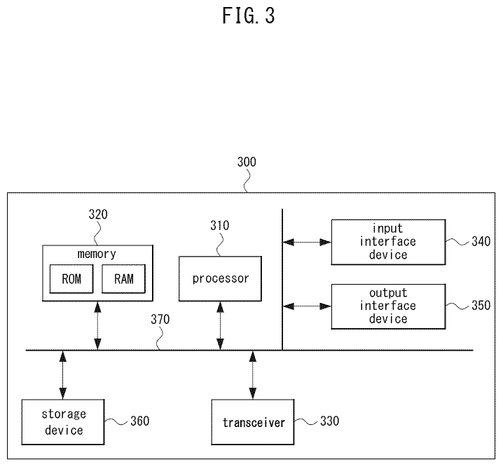

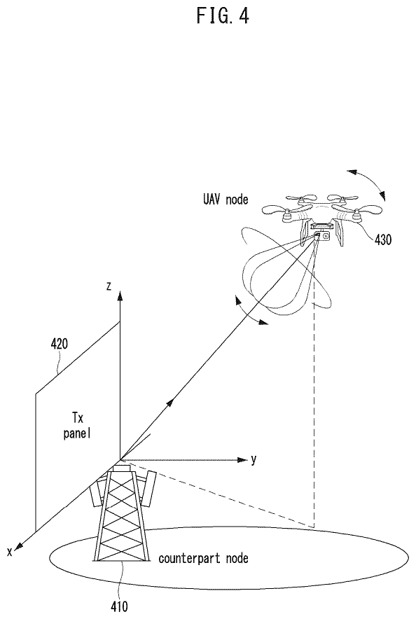

FIG. 4 is a schematic diagram of a scenario in which a terrestrial base station supports a UAV terminal in the present exemplary embodiment. FIG. 5 is an illustrative diagram describing azimuth angle (α,β,γ) information of a UAV node.

Referring to FIGS. 4 and 5, a counterpart node 410, acting as a terrestrial base station, may support a UAV node 430, which is a UAV terminal, based on pre-stored configurations. To this end, the counterpart node 410 may communicate with the UAV node 430 through a transmission panel (Tx panel) 420 or a transceiver panel, which is configured with multiple antennas. Here, the counterpart node 410 may include a terrestrial base station supporting UAVs or another UAV (or another UAV node) connected through an inter-UAV communication link.

The UAV node 430, as a communication node, may be equipped with a multi-antenna array and may be configured to use a beamforming technology to generate directional beams in millimeter-wave communication, allowing it to overcome path loss over long distances and improve the quality of transmitted and received millimeter-wave signals. Specifically, the UAV node 430 may be configured to determine a beamformer based on UAV jitter information, and may also be configured to modify or configure a beam codebook based on UAV jitter information.

The UAV node 430 may be configured so that the antenna panel is mounted facing vertically downward on an x-y plane (see FIG. 5). The antenna panel may include a reception panel (Rx panel).

As described above, the processors included in the UAV node 430, the counterpart node 410, or in either of them, may each be configured to perform a step of obtaining UAV jitter information and a step of determining a UAV transmission and reception technique to enable robust communication against UAV jitters.

The UAV jitter information may refer to information that may be utilized for modifying a transmission and reception technique of the UAV node 430, such as information on changes in angle-of-arrival (AoA) or angle-of-departure (AoD) of an antenna array mounted on the UAV node 430 experiencing body disturbance. The UAV jitter information may include information on a statistically derived probability distribution, such as a mean or covariance, or may include measurable data from sensor device(s) embedded in the UAV node 430 (hereinafter simply referred to as ‘sensor’).

### UAV Jitter Information Acquisition Step

The UAV jitter information acquisition step may be classified into two cases based on an entity acquiring the UAV jitter information: one where the UAV node 430 directly acquires the information and another where the counterpart node 410 acquires the information.

Furthermore, the case where the UAV node 430 directly acquires the UAV jitter information may be classified into three cases. First, the information may be analytically derived by additionally utilizing data from the counterpart node 410. Second, the UAV jitter information may measured and acquired through signaling with the counterpart node 410, Third, the information may measured through the embedded sensor device of the UAV node 430.

A more detailed description of the direct acquisition by the UAV node 430 is as follows.

In this case, the UAV jitter information acquisition step may include analytically deriving the UAV jitter information by additionally utilizing information from the counterpart node 410. During this step, the UAV node 430 may be configured to receive necessary information for calculating a UAV jitter from the counterpart node 410 in form of a jitter reference signal (JRS) and to use it for the aforementioned calculations. The information received from the counterpart node 410 as the jitter reference signal may include a relative position relationship between the UAV node 430 and the counterpart node 410, which is calculated using global positioning system (GPS) information and altitude information of the counterpart node 410.

Additionally, when analytically deriving the UAV jitter information using data from the counterpart node 410, the UAV jitter information acquisition step may be configured to further utilize information measured by the embedded sensors of the UAV node 430, in addition to the information received in form of the jitter reference signal.

Furthermore, the step in which the UAV node 430 directly acquires the UAV jitter information may include not only obtaining it through the jitter reference signal transmitted by the counterpart node 410 but also measuring the UAV jitter information through signaling with the counterpart node. In this case, the UAV node 430 may receive a pilot signal from the counterpart node 410 to calculate the UAV jitter information, or after acquiring the UAV jitter information, use the received pilot signal in a subsequent correction step. The information measurable through the pilot signal may include an Angle of Arrival (AoA) from the counterpart node 410.

Additionally, the step in which the UAV node 430 directly acquires the UAV jitter information may be configured to obtain UAV jitter information measured by the embedded sensors of the UAV node 430 or information calculated based on the measured data. The information measured by the embedded sensors may be used to acquire the UAV jitter information in addition to the information obtained through the jitter reference signal described above or through measurements made via signaling.

The information measured by the embedded sensors of the UAV node 430 may include the UAV node's 430 location information obtained using GPS information and altitude information, or statistical metrics such as an azimuth angle of the UAV node 430 and its variance, which can be measured using a gyroscope, accelerometer, and etc.

Then, a more detailed description of the process in which the counterpart node 410 acquires the UAV jitter information is as follows.

When the counterpart node 410 acquires the UAV jitter information, it is not possible to measure a change in the UAV node's 430 azimuth angle by the counterpart node 410. Therefore, to obtain the UAV jitter information that includes this data, it is necessary to acquire the required information from the UAV node 430.

Therefore, when the counterpart node 410 acquires the UAV jitter information, the UAV jitter information acquisition step may be classified into two cases: one in which all necessary information is obtained in the form of the jitter reference signal from the UAV node 430, and another in which some information is acquired in the form of the jitter reference signal while the remaining information is measured from pilot signals. When all information is acquired in the form of the jitter reference signal, the jitter reference signal received from the UAV node 430 may include location information of the UAV node 430 obtained using GPS and altitude information, or statistical metrics such as the azimuth angle changes or its distribution of the UAV measured using instruments such as gyroscopes or accelerometers.

Meanwhile, in cases where some information is acquired in the form of the jitter reference signal and the remaining information is measured from the pilot signal, location information of the UAV node 430 obtained using GPS and altitude information, or statistical metrics, such as the azimuth angle or its distribution of the UAV, measurable with instruments such as gyroscopes or accelerometers, may be included in the jitter reference signal received from the UAV node 430. The information measured from the pilot signal may include the AoA from the UAV node 430.

### UAV Transmission and Reception Technique Determination Step

When determining a transmission and reception technique for the UAV node 430, considering UAV jitter, the determination process may be classified into two cases based on an entity responsible for making the determination: one in which the UAV node 430 directly makes the determination and another in which the counterpart node 410 or a server connected to the counterpart node 410 makes the determination. Additionally, if a transmission and reception technique is determined by the counterpart node 410 or a server connected to the counterpart node 410, the determination process may further be classified into a scheme of obtaining UAV jitter information by the UAV node 430 itself or a scheme of obtaining UAV jitter information by the counterpart node 410.

Examples of the transmission and reception technique may include configuring a beamformer of the UAV node 410 or adjusting a beam codebook of the UAV node 410. These techniques may be determined by referring to the information obtained in the UAV jitter information acquisition step.

First, when the UAV node 430 directly determines the transmission and reception technique, this determination step may be classified into two cases: one where the UAV jitter information is acquired and utilized directly by the UAV node 430 itself, and another where the UAV node 430 utilizes the UAV jitter information obtained from the counterpart node 410.

Specifically, when the UAV node 430 acquires and utilizes the UAV jitter information directly, a transmission and reception technique determined by the UAV node 430 may include determination of a beamformer or beam codebook of the UAV node 430.

If the determination of transmission and reception technique involves determining or configuring the beamformer for the UAV node 430, the UAV jitter information acquired and utilized by the UAV node 430 may include details such as a relative positional relationship between the UAV node 430 and the counterpart node 410, statistical metrics such as a change in an azimuth angle of the UAV node 430 and its distribution, or information on an AoA from the counterpart node 410 and an AoD toward the counterpart node 410.

Additionally, if the determination of the transmission and reception technique involves determining or configuring a beam codebook for the UAV node 430, the UAV jitter information acquired and utilized by the UAV node 430 may include statistical metrics such as a change in the azimuth angle of the UAV node 430 and its distribution, or positional information such as the altitude of the UAV node 430.

Meanwhile, when the UAV jitter information is acquired and received from the counterpart node 410, the transmission and reception technique determined by the UAV node 430 may include determining a beamformer for the UAV node 430. If the transmission and reception technique involves determining or configuring a beamformer for the UAV node 430, the UAV jitter information acquired and utilized by the counterpart node 410 may include a relative positional relationship between the UAV node 430 and the counterpart node 410, or information such as an AoA from the UAV node 430 and an AoD toward the UAV node 430.

To utilize the UAV jitter information in the UAV transmission and reception technique determination step, the UAV node 430 may need an additional process of receiving the UAV jitter information from the counterpart node 410. The UAV node 430 may then transmit information on the changed UAV transmission and reception technique to the counterpart node 410.

Then, the process in which the counterpart node 410 determines the transmission and reception technique will be described.

When the transmission and reception technique is determined by the counterpart node, the determination step may be classified into two cases: one where the counterpart node 410 directly acquires and utilizes the UAV jitter information, and another where the counterpart node 410 utilizes UAV jitter information measured and received from the UAV node 430. In both cases, the process may involve the counterpart node 410 transmitting the determined transmission and reception technique to the UAV node 430.

Specifically, when the UAV jitter information is directly acquired and utilized by the counterpart node 410, the transmission and reception technique determined by the counterpart node 410 may include configuring or determining a beamformer or beam codebook for the UAV node 430.

If the determination of transmission and reception technique involves determining and configuring the beamformer for the UAV node 430, the UAV jitter information acquired and utilized by the counterpart node 410 may include a relative positional relationship between the UAV node 430 and the counterpart node 410, statistical metrics such as an azimuth angle of the UAV node 430 or its distribution, and information such as an AoA from the UAV node 430 and an AoD toward the UAV node 430.

Additionally, if the determination of transmission and reception technique involves determining or configuring a beam codebook for the UAV node 430, the UAV jitter information acquired and utilized by the counterpart node 410 may include statistical metrics, such as an azimuth angle of the UAV node 430 and its distribution, or positional information such as the altitude of the UAV node 430.

Meanwhile, if the UAV jitter information acquired by the UAV node 430 is transferred and utilized, the transmission and reception technique determined by the counterpart node 410 may include a beamformer or beam codebook for the UAV node 430.

If the transmission and reception technique involves determining and configuring a beamformer for the UAV node 430, the UAV jitter information acquired and transmitted by the UAV node 430 to the counterpart node 410 may include a relative positional relationship between the UAV node 430 and the counterpart node 410, or information such as an AoA from the counterpart node 410 and an AoD toward the counterpart node 410.

Additionally, if the transmission and reception technique involves determining or configuring a beam codebook for the UAV node 430, the UAV jitter information acquired and transferred by the UAV node 430 to the counterpart node 410 may include statistical metrics, such as an azimuth angle and its distribution for the UAV node 430, or positional information such as the altitude of the UAV node 430.

Furthermore, when UAV jitter information is directly acquired and utilized by the counterpart node 410, the transmission and reception technique determined at the counterpart node 410 may include a beamformer or beam codebook for the counterpart node 410.

When the UAV jitter information is acquired and utilized by the counterpart node 410, the transmission and reception technique determined may involve determining a beamformer or beam codebook for the counterpart node 410.

When the transmission and reception technique involves determining or configuring a beamformer for the counterpart node 410, the UAV jitter information acquired and utilized by the counterpart node 410 may include a relative positional relationship between the UAV node 430 and the counterpart node 410, or information such as an AoA from the UAV node 430 and an AoD toward the UAV node 430.

Additionally, when the transmission and reception technique involves determining or configuring a beam codebook for the counterpart node 410, the UAV jitter information utilized may include statistical metrics such as an azimuth angle or its distribution of the counterpart node 410, or location information such as the altitude of the counterpart node 410.

Hereinafter, specific examples of robust communication methods for UAV millimeter-wave communication, which may be adopted by the aforementioned UAV jitter information acquisition step and the UAV transmission and reception technique determination step, will be described in detail.

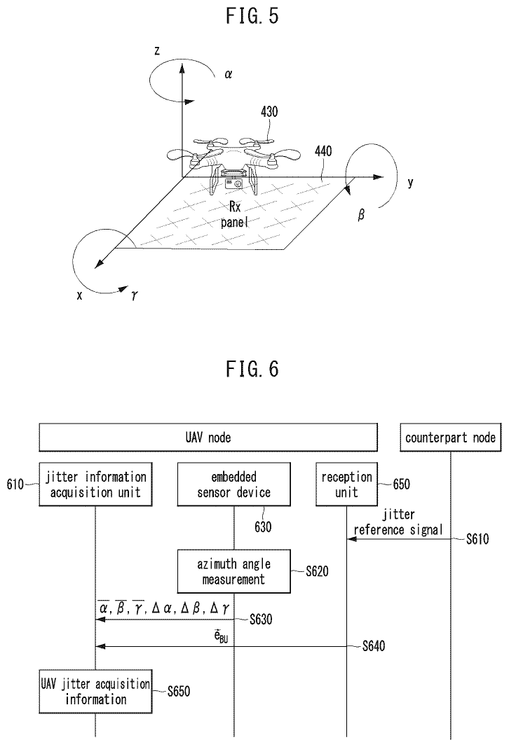

FIG. 6 is a signal flow diagram illustrating a case where UAV jitter information is acquired using information from the counterpart node according to the present exemplary embodiment.

In the present exemplary embodiment, in a scenario where a terrestrial base station supports a UAV node, the UAV node acquires UAV jitter information by additionally utilizing information from a counterpart node. Through this, the UAV node may determine a reception beamformer to be used by the UAV node.

In the present exemplary embodiment, the UAV node may be referred to as a UAV terminal, and the counterpart node may be referred to as the terrestrial base station. The UAV node may be equipped with a jitter information acquisition unit 610, an embedded sensor device 630, and a reception unit 650. Additionally, both the terrestrial base station and the UAV terminal may be equipped with a uniform planar array (UPA) antenna.

Specifically, as illustrated in FIG. 6, an operational principle of the communication method in the present exemplary embodiment is as follows. First, the UAV node may periodically or aperiodically receive a jitter reference signal from the counterpart node through the reception 650 (S610), and may receive necessary information for obtaining UAV jitter information through the jitter reference signal.

The jitter reference signal may include information such as an index of a transmission (Tx) beam operated by the terrestrial base station, which may be used to obtain AoD information from the counterpart node. Through this jitter reference signal, the UAV node may obtain a unit vector that includes information on the relative positional relationship from the terrestrial base station to the UAV node. This unit vector \vec{e}_{BU} may be transferred from the reception unit 650 to the jitter information acquisition unit 610 (S640).

Meanwhile, the embedded sensor device 630 included in the UAV node may measure a change in an azimuth angle of the UAV node S620. Using this information on the change in the azimuth angle, the embedded sensor device 630 or the UAV node may obtain a mean and variance for each azimuth angle value. Furthermore, the UAV node or the embedded sensor device 630 may transmit information on the mean (α̅, β̅, γ̅) and variance (Δα, Δβ, Δγ) of each azimuth angle value to the jitter information acquisition unit 610 (S630).

The jitter information acquisition unit 610 may receive values or information regarding the mean and variance of each azimuth angle from the embedded sensor device 630 or the UAV node S630, and may also receive a unit vector calculated based on the jitter reference signal from the receiver 650 or a computational unit of the UAV node (S640).

The UAV node may acquire UAV jitter information using the values obtained through the jitter reference signal and the embedded sensor device 630 (S650). Specifically, the UAV node may calculate a mean and variance of its own AoA distribution based on the unit vector and the mean and variance values of each azimuth angle.

According to the present exemplary embodiment, the UAV node may derive an angle of arrival (AoA) of a signal at the UAV node by using its own azimuth angles (α, β, γ), the angle of departure (AoD) obtained from the communication signals, such as pilot signals, received from the counterpart node, and the unit vector(\vec{e}_{BU}). These may be expressed as in Equation 1 and Equation 2 below.

$${Ω}_{U , x} ( α , β , γ ) = {[ 1 , 0 , 0 ]}^{T} {R}^{T} ( α , β , γ ) {\vec{e}}_{B U} \qquad [ Equation 1 ]$$

$${Ω}_{U , y} ( α , β , γ ) = {[ 0 , 1 , 0 ]}^{T} {R}^{T} ( α , β , γ ) {\vec{e}}_{B U} \qquad [ Equation 2 ]$$

In Equations 1 and 2, Ω_{U,x}(α, β, γ) represents the angle of arrival (AoA) in the x-axis direction, while Ω_{U,y}(α, β, γ) represents the AoA in the y-axis direction. [1, 0, 0]^{T} denotes the unit vector in the positive x-axis direction, and [0, 1, 0]^{T} denotes the unit vector in the positive y-axis direction. R^{T}(α, β, γ) represents a transpose matrix of a 3D rotation transformation, and (\vec{e}_{BU}) represents the unit vector. The 3D rotation transformation R(α,β,γ) from Equations 1 and 2 is shown in Equation 3.

$$R = [ \begin{matrix}cos α cos β & \begin{matrix}cos αsinβsinγ - \\ sin αcosγ\end{matrix} & cos αsinβcosγ + sin αsinγ \\ sin αcosβ & \begin{matrix}sin αsinβsinγ + \\ cos αcosγ\end{matrix} & sin αsinβcosγ - cos αsinγ \\ - sin β & cos βsinγ & cos βcosγ\end{matrix} ] \qquad [ Equation 3 ]$$

In Equation 3, the 3D transformation indicates that an antenna panel on the UAV node is mounted such that it faces downward on the xy-plane. The antenna panel may include a reception panel (Rx panel) (see FIG. 5 for reference). The mean (μ) and variance (Σ) of the Angle of Arrival (AoA) at the UAV node, and the UAV jitter information, J(α,β,γ), based on these mean and variance values, are represented in Equations 4 to 6. The mean, variance, and UAV jitter information values are derived from information obtained through the jitter reference signal and the embedded sensors, calculated using Equations 1 to 3.

$$μ = [ \begin{matrix}{\overline{Ω}}_{U , x} \\ {\overline{Ω}}_{U , y}\end{matrix} ] \qquad [ Equation 4 ]$$

$$\sum = J [ \begin{matrix}{σ}_{α}^{2} & 0 & 0 \\ 0 & {σ}_{β}^{2} & 0 \\ 0 & 0 & {σ}_{γ}^{2}\end{matrix} ] {J}^{T} \qquad [ Equation 5 ]$$

$$J ( α , β , γ ) = [ \begin{matrix}\frac{\partial {Ω}_{U , x}}{\partial α} & \frac{\partial {Ω}_{U , x}}{\partial β} & \frac{\partial {Ω}_{U , x}}{\partial γ} \\ \frac{\partial {Ω}_{U , y}}{\partial α} & \frac{\partial {Ω}_{U , y}}{\partial β} & \frac{\partial {Ω}_{U , y}}{\partial γ}\end{matrix} ] \qquad [ Equation 6 ]$$

According to the present exemplary embodiment, the UAV node that has acquired the UAV jitter information may utilize the UAV jitter information to design a reception beamformer for receiving downlink signals from the counterpart node. In particular, it enables the use of a beam-widening technique, where a reception beamformer gain is maximized in an average AoA direction, and a beamwidth of a main lobe is appropriately adjusted based on the AoA variance.

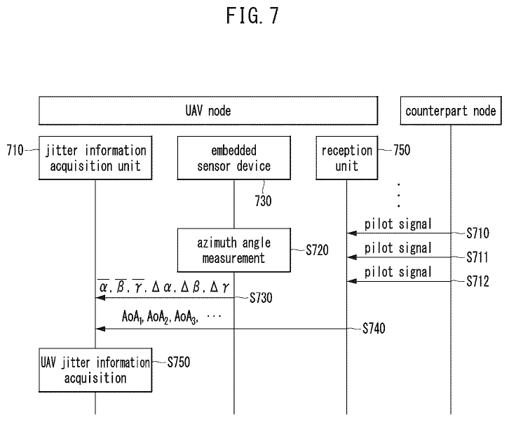

FIG. 7 is a signal flow diagram illustrating a case in which UAV jitter information is obtained by utilizing information measured from the counterpart node in the present exemplary embodiment.

The present exemplary embodiment pertains to a scenario where a terrestrial base station supports a UAV node, and the UAV node acquires UAV jitter information based on information measured by the counterpart node. Through this process, the UAV node may determine a reception beam codebook to be used by the UAV node.

In the present exemplary embodiment, the UAV node refers to a UAV terminal, and the counterpart node may refer to a terrestrial base station. The UAV node may include a jitter information acquisition unit 710, an embedded sensor device 730, and a reception unit 750. Additionally, each of the terrestrial base station and the UAV mode may be equipped with a uniform planar array (UPA) antenna.

Specifically, as illustrated in FIG. 7, the detailed operation of the communication method according to the present exemplary embodiment is as follows: the UAV node may receive pilot signals for AoA measurements periodically or aperiodically from the counterpart node (S710, S711, S712). The embedded sensor device 730 equipped on the UAV node may measure a change in azimuth angles of the UAV node (S720). Using information on the change in the azimuth angle, the embedded sensor device 730 or the UAV node may obtain a mean and variance of each azimuth angle value. Additionally, the UAV node or the embedded sensor device 730 may transmit information on the mean (α̅, β̅, γ̅) and variance (Δα, Δβ, Δγ) of each azimuth angle value to the jitter information acquisition unit 710 (S730).

Meanwhile, the UAV node may obtain multiple angles of arrival (AoA₁, AoA₂, AoA₃, . . . , and the like) based on the pilot signals received from the counterpart node. These AoAs may be transferred from the reception unit 750 to the jitter information acquisition unit 710 (S740).

The jitter information acquisition unit 710 may receive the values or information on the mean and variance of each azimuth angle value from the embedded sensor device 730 or the UAV node (S730), and may also receive the AoAs (AoA₁, AoA₂, AoA₃, . . . , and the like) calculated based on the respective pilot signals from the reception unit 750 or from a computation unit of the UAV node (S740).

The UAV node may obtain current UAV jitter information based on the AoA information measured from the counterpart node and the azimuth angle information obtained through measurements of the embedded sensor device 630 (S750). Through this, the UAV node may operate a beam codebook to have a coverage angle that supports wider coverage according to a level of the UAV jitter for each codebook used for signal transmission and reception, based on the AoA information and the mean and variance of each azimuth angle value.

According to the present exemplary embodiment, the UAV node can reliably acquire current UAV jitter information at the UAV node by using the mean and variance obtained based on its own azimuth angles (α, β, γ) and the AoAs measured from the pilot signals transmitted by the counterpart node. This enables the UAV node to selectively operate its codebook or effectively configure a beamformer.

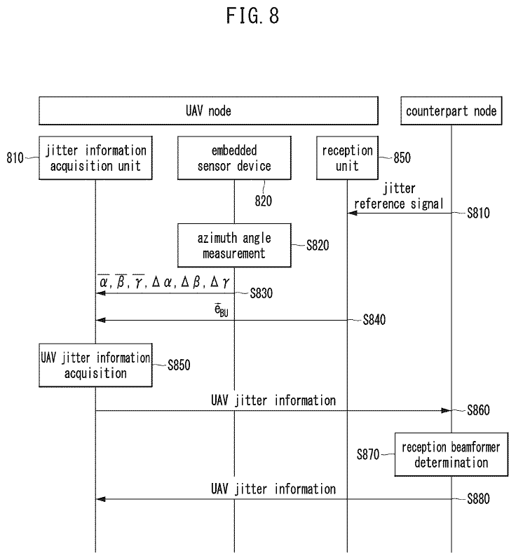

FIG. 8 is a signal flow diagram illustrating an exemplary embodiment in which UAV jitter information is obtained using information from a counterpart node, and the counterpart node determines a reception beamformer for a UAV node.

The present exemplary embodiment pertains to a scenario in which a counterpart node, such as a terrestrial base station, supports a UAV node. In this case, the UAV node may obtain UAV jitter information based on information from the counterpart node and measurements from its embedded sensor, and then transmit the UAV jitter information to the counterpart node. Using this information, the counterpart node may determine a reception beamformer to be used by the counterpart node. Information on the reception beamformer determined by the counterpart node may then be delivered to the UAV node.

The UAV node may be equipped with a jitter information acquisition unit 810, an embedded sensor device 820, and a reception unit 850. Additionally, each of the terrestrial base station and the UAV node may be equipped with a uniform planar array (UPA) antenna.

Specifically, with reference to FIG. 8, the operational principle of the communication method according to the present exemplary embodiment is as follows: the UAV node may receive a jitter reference signal periodically or aperiodically from the counterpart node through the reception unit 850 (S810), and the UAV node may obtain necessary information to obtain UAV jitter information through the jitter reference signal.

The jitter reference signal may include information such as an index of a transmission (Tx) beam operated by the counterpart node, which enables extraction of angle of departure (AoD) information from the counterpart node. Through this jitter reference signal, the UAV node may obtain a unit vector (\vec{e}_{BU}) that includes information on a relative positional relationship from the counterpart node to the UAV node. The unit vector may then be transferred from the reception unit 850 to the jitter information acquisition unit 810 (S840).

Meanwhile, the embedded sensor device 820 mounted on the UAV node may measure a change in an azimuth angle of the UAV node (S820). Using information on the change in the azimuth angle, the embedded sensor device 820 or the UAV node may calculate a mean (α̅, β̅, γ̅) and variance (Δα, Δβ, Δγ) of each azimuth angle value. The UAV node or the embedded sensor device 820 may transmit information on the mean and variance of each azimuth angle value to the jitter information acquisition unit 810 (S830).

The jitter information acquisition unit 810 may receive the values or information on the mean and variance of each azimuth angle value from the embedded sensor device 820 or the UAV node (S830). Additionally, the jitter information acquisition unit 810 may receive the unit vector calculated based on the jitter reference signal from the receiver 850 or from a computational unit of the UAV node (S840).

The UAV node may obtain UAV jitter information by using the values obtained through the jitter reference signal and the values obtained through the embedded sensor device 820 (S850). Specifically, the UAV node may calculate a mean and variance of its own AoA distribution based on the unit vector and the mean and variance of each azimuth angle value. This process may follow Equations 1 to 6.

Subsequently, through the aforementioned process, the UAV node may transmit the obtained UAV jitter information to the counterpart node (S860). Based on the UAV jitter information received from the UAV node, the counterpart node may determine a reception beamformer for the UAV node (S870). Specifically, the counterpart node may control signal transmission and reception using a beam-widening technique where a reception beamformer gain is maximized in a direction of the mean AoA, and a beamwidth of a main lobe is appropriately adjusted according to the AoA variance.

The counterpart node may transfer the reception beamformer derived from the above process to the UAV node (S880). Based on information on the reception beamformer received from the counterpart node, the UAV node may maintain, configure, or adjust its transmission beamformer, and in addition, it may optionally determine a beam codebook.

According to the present exemplary embodiment, the UAV node may provide the counterpart node with UAV jitter information obtained by utilizing its azimuth angles (α, β, γ) and information from the counterpart node. This allows the counterpart node to adjust or determine an operating condition of the reception beamformer for the UAV node, thereby establishing a high-efficiency and high-reliability communication environment with the counterpart node.

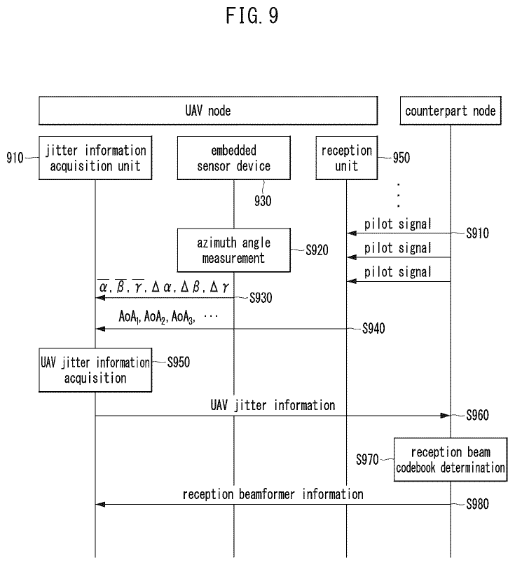

FIG. 9 is a signal flow diagram illustrating an exemplary embodiment in which UAV jitter information is obtained using information measured from a counterpart node, and the counterpart node determines a reception beam codebook for a UAV node.

The present embodiment pertains to a scenario in which a counterpart node which is a terrestrial base station supports a UAV node which serves as a UAV terminal. In this scenario, the UAV node may obtain UAV jitter information based on information received from the counterpart node and information measured by its embedded sensor device, then transmit the UAV jitter information to the counterpart node. Through this process, the counterpart node may determine a reception beam codebook to be used by the counterpart node, and information on the beam codebook of the counterpart node may then be transmitted to the UAV node.

The UAV node may be equipped with a jitter information acquisition unit 910, an embedded sensor device 930, and a reception 950. Additionally, each of the terrestrial base station and the UAV node may be equipped with uniform planar array (UPA) antenna.

Specifically, referring to FIG. 9, the operational principle of the communication method according to the present exemplary embodiment is as follows: the UAV node may periodically or aperiodically receive pilot signals from the counterpart node for AoA measurement (S910).

The embedded sensor device 930 mounted on the UAV node may measure a change in an azimuth angle of the UAV node (S920). Using information on the change in the azimuth angle, the embedded sensor device 930 or the UAV node may obtain a mean and variance of each azimuth angle value. Additionally, the UAV node or embedded sensor device 930 may transmit information on the mean (α̅, β̅, γ̅) and variance (Δα, Δβ, Δγ) of each azimuth angle value to the jitter information acquisition unit 910 (S930).

Meanwhile, the UAV node may obtain multiple AoAs (AoA₁, AoA₂, AoA₃, . . . , and the like) based on pilot signals received from the counterpart node. The AoAs may be transferred from the reception unit 950 to the jitter information acquisition unit 910 (S940).

The jitter information acquisition unit 910 may receive the values or information on the mean and variance of each azimuth angle from the embedded sensor device 930 or the UAV node S930. The jitter information acquisition unit 910 may also receive the AoAs (AoA₁, AoA₂, AoA₃, . . . , and the like), or AoA-related information, calculated based on each of the pilot signals, from the reception unit 950 or a computation unit of the UAV node (S940).

The UAV node may obtain current UAV jitter information based on the AoA information measured from communication signals from the counterpart node and the azimuth angle information obtained through the embedded sensor device 630 (S950). By doing so, the UAV node may manage each beam codebook for signal transmission and reception to have a coverage angle suitable for wider coverage depending on a level of a UAV jitter, based on the AoA information and the mean and variance of each azimuth angle value.

Additionally, the UAV node may transmit the obtained UAV jitter information to the counterpart node through the aforementioned process (S960). Based on the UAV jitter information received from the UAV node, the counterpart node may determine a reception beam codebook for the UAV node (S970). Specifically, the counterpart node may be configured to manage each beam codebook with a coverage angle that accommodates wider coverage, depending on the level of the UAV jitter for each codebook.

The counterpart node may transmit information on the reception beam codebook derived through the above process to the UAV node (S980). Based on information on the reception beam codebook received from the counterpart node, the UAV node may maintain or adjust its transmission beam codebook and, optionally, maintain or adjust its transmission beamformer as well.

In the present exemplary embodiment, the UAV node may provide UAV jitter information obtained from its azimuth angle (α, β, γ) and information measured from the counterpart node's transmission signal to the counterpart node. This enables the counterpart node to determine a reception beam codebook for the UAV node, thereby establishing an efficient and reliable signal transmission and reception environment with the counterpart node.

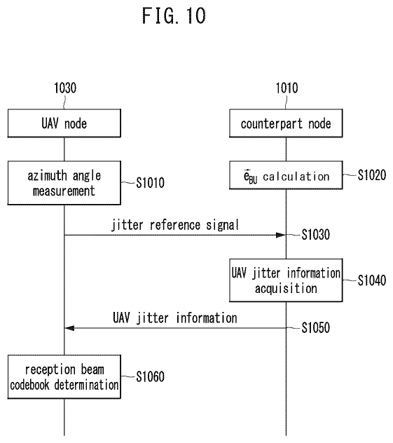

FIG. 10 is a signal flow diagram illustrating an exemplary embodiment in which UAV jitter information is obtained using information from a UAV node, and the UAV node determines a reception beam codebook for the UAV node.

The present exemplary embodiment pertains to a scenario where a counterpart node 1010 which is a terrestrial base station supports a UAV node 1030 which is a UAV terminal. In this case, the counterpart node 1010 may obtain UAV jitter information based on a jitter reference signal received from the UAV node 1030. The counterpart node 1010 may then transmit the UAV jitter information to the UAV node 1030, and the UAV node 1030 may determine a reception beamformer to be used based on the UAV jitter information received from the counterpart node 1010.

The UAV node 1030 may be equipped with a jitter information acquisition unit, an embedded sensor device, and a reception unit. Similarly, the counterpart node 1010 may also be equipped with a jitter information acquisition unit and a reception unit. Each of the terrestrial base station and the UAV terminal may include a uniform planar array (UPA) antenna.

Specifically, as illustrated in FIG. 10, the detailed operational principle of the communication method according to the present exemplary embodiment is as follows: the UAV node 1030 may measure a change in its azimuth angle through its embedded sensor device (S1010).

Meanwhile, the counterpart node 1010 can calculate a unit vector (\vec{e}_{BU}) that includes information on a relative positional relationship from the UAV node 1030 to the counterpart node 1010 (S1020).

The UAV node 1030 may periodically or aperiodically transmit a jitter reference signal to the counterpart node (1010), including information on the change in the azimuth angle (S1030). The jitter reference signal may include information on the change in the azimuth angle of the UAV node 1030 measured by the embedded sensor device, the AoA information of the UAV node 1030, and the relative positional relationship from the counterpart node 1010 to the UAV node 1030.

Furthermore, after receiving the jitter reference signal, the counterpart node 1010 may be configured to calculate the unit vector (\vec{e}_{BU}) that includes information on the relative positional relationship from the UAV node 1030 to the counterpart node 1010.

In the above-described manner, the counterpart node 1010 may obtain necessary information to obtain the UAV jitter information periodically or aperiodically via the jitter reference signal received from the UAV node (1030).

Additionally, the counterpart node 1010 may obtain UAV jitter information by additionally utilizing information known to itself, such as the unit vector, in addition to the jitter reference signal received from the UAV node 1030 (S1040). The information available at the counterpart node 1010 may include information that allows it to extract AoD information from the UAV node 1030, such as a transmission (Tx) beam index of the UAV node 1030.

Using the jitter reference signal and the calculated unit vector, the counterpart node 1010 may obtain UAV jitter information, namely the mean and variance of the AoA distribution of the UAV node 1030. This process for obtaining UAV jitter information may follow the basic procedures outlined in Equations 1 to 6.

The counterpart node 1010 may transmit the UAV jitter information obtained through the aforementioned process to the UAV node 1030 (S1050). Based on the UAV jitter information received from the counterpart node 1010, the UAV node 1030 may determine its reception beamformer (S1060). Specifically, the UAV node 1030 may be configured to control signal transmission and reception using a beam-widening technique, which maximizes a reception beamformer gain in the average AoA direction and appropriately adjusts a main lobe's beamwidth according to the AoA variance.

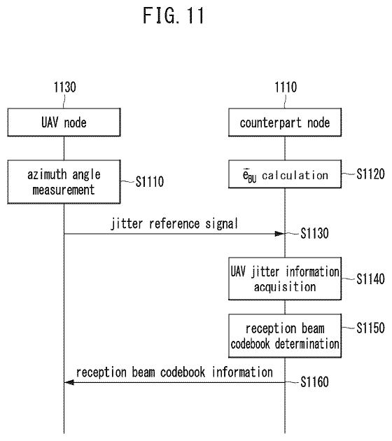

FIG. 11 is a signal flow diagram illustrating an exemplary embodiment in which UAV jitter information is obtained using information from a UAV node, and a counterpart node determines a reception beam codebook for the UAV node.

The present exemplary embodiment pertains to a scenario in which a counterpart node 1110 which is a terrestrial base station supports a UAV node 1130 which is a UAV terminal. In this scenario, the counterpart node 1110 may obtain UAV jitter information based on a jitter reference signal received from the UAV node 1130. The counterpart node 1110 may transmit the UAV jitter information to the UAV node 1130, and the UAV node 1130 may determine a reception beamformer to be used by the UAV node based on the UAV jitter information received from the counterpart node 1110.

The UAV node 1130 may be equipped with a jitter information acquisition unit, an embedded sensor device, and a reception unit. Similarly, the counterpart node 1110 may also be equipped with a jitter information acquisition unit and a reception unit. Additionally, each of the terrestrial base station and the UAV terminal may have a uniform planar array (UPA) antenna.

Specifically, as illustrated in FIG. 11, the operational principle of the communication method according to the present exemplary embodiment may be as follows: the UAV node 1130 may measure a change in its azimuth angle through the embedded sensor device (S1110).

Meanwhile, the counterpart node 1110 may calculate a unit vector (\vec{e}_{BU}) that includes information on a relative positional relationship from the UAV node 1130 to the counterpart node 1110 (S1120).

The UAV node 1130 may transmit a jitter reference signal including information on the change in the azimuth angle periodically or aperiodically to the counterpart node 1110 (S1130). The jitter reference signal may include information on the change in the azimuth angle measured by the embedded sensor device of the UAV node 1130, the AoA information of the UAV node 1130, and the information on the relative positional relationship from the counterpart node 1110 to the UAV node 1130.

Additionally, after receiving the jitter reference signal, the counterpart node 1110 may be configured to calculate the unit vector (\vec{e}_{BU}) that includes information on the relative positional relationship from the UAV node 1130 to the counterpart node 1110.

In the above-described manner, the counterpart node 1110 may obtain necessary information for obtaining the UAV jitter information through the jitter reference signal received periodically or aperiodically from the UAV node 1130.

Additionally, the counterpart node 1110 may use the jitter reference signal received from the UAV node 1130, along with additional information it may independently determine, such as the unit vector, to obtain the UAV jitter information (S1140). The information available to the counterpart node 1110 may include information such as a transmission (Tx) beam index of the UAV node 1130 or other information that provides an AoD of a signal originating from the UAV node 1130.

The counterpart node 1110 may obtain the UAV jitter information, specifically the mean and variance of the AoA distribution of the UAV node 1130, by utilizing the jitter reference signal and the independently calculated unit vector. This process of obtaining the UAV jitter information may follow Equations 1 to 6.

Additionally, the counterpart node 1110 may determine a reception beam codebook for the UAV node 1130 based on the UAV jitter information obtained through the aforementioned process (S1150).

Subsequently, after determining the reception beam codebook for the UAV node 1130 based on this UAV jitter information, the counterpart node 1110 may transmit information on the determined reception beam codebook to the UAV node 1130 (S1160).

The UAV node 1130 may determine its transmission beamformer or determine its transmission beam codebook based on the information on the reception beam codebook received from the counterpart node 1110. Specifically, the UAV node 1130 may be configured to control a transmission signal using a beam-widening technique, where a transmission beamformer gain is maximized in the average AoD direction, and a beamwidth of a main lobe is appropriately adjusted according to the AoD variance.

Meanwhile, although most of the foregoing exemplary embodiments have been described for simplicity with a focus on a single UAV terminal and a single terrestrial base station, the present disclosure is not limited to this configuration. It may also be implemented between one UAV terminal (or the first UAV terminal) and another UAV terminal (or the second UAV terminal). In this case, the first UAV terminal may be simply referred to as a UAV node, and the second UAV terminal may be referred to as a counterpart node.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method for performing unmanned aerial vehicle (UAV) jitter-resistant communication in a communication system using a UAV, performed by a UAV node, comprising:
acquiring UAV jitter information for the UAV node; and
determining a UAV transmission and reception technique based on the UAV jitter information,
wherein the UAV transmission and reception technique includes determination or configuration of a beamformer or a codebook to perform signal transmission and reception robust against a UAV jitter between the UAV node and a counterpart node.

2. The method according to claim 1, wherein the acquiring of the UAV jitter information comprises:
receiving a jitter reference signal from the counterpart node;
calculating a mean and variance of each azimuth angle measured by an embedded sensor device of the UAV node; and
obtaining the UAV jitter information based on a unit vector derived from the jitter reference signal and the calculated mean and variance.

3. The method according to claim 2, wherein the jitter reference signal includes information on an index of a transmission (Tx) beam operated by the counterpart node, which is a terrestrial base station, and includes information related to an angle of departure (AoD) from the counterpart node.

4. The method according to claim 1, wherein the acquiring of the UAV jitter information comprises:
receiving pilot signals from the counterpart node;
calculating a mean and variance for each azimuth angle measured by an embedded sensor device of the UAV node; and
obtaining the UAV jitter information based on the mean and variance and information on angles of arrival (AoAs) calculated from information derived from the pilot signals.

5. The method according to claim 1, further comprising:
transmitting the UAV jitter information to the counterpart node; and
receiving information on a reception beamformer for the UAV node from the counterpart node, the reception beamformer being determined by the counterpart node based on the UAV jitter information.

6. The method according to claim 1, further comprising:
transmitting the UAV jitter information to the counterpart node; and
receiving information on a reception beam codebook for the UAV node from the counterpart node, the reception beam codebook being determined by the counterpart node based on the UAV jitter information.

7. A method for performing unmanned aerial vehicle (UAV) jitter-resistant communication in a communication system using a UAV, performed by a UAV node, comprising:
transmitting a jitter reference signal to a counterpart node, the jitter reference signal including information on a change in an azimuth angle measured by an embedded sensor device of the UAV node;
receiving, from the counterpart node, UAV jitter information obtained by utilizing the jitter reference signal and a unit vector calculated by the counterpart node; and
determining a reception beamformer based on the UAV jitter information.

8. The method according to claim 7, wherein the jitter reference signal includes information on a change in an azimuth angle of the UAV node, angle of arrival (AoA) information of the UAV node, and information on a relative positional relationship from the counterpart node to the UAV node.

9. The method according to claim 7, wherein the unit vector includes information related to an angle of departure (AoD) of a signal from the UAV node, based on a transmission beam index of the UAV node.

10. An apparatus for performing unmanned aerial vehicle (UAV) jitter-resistant communication in a communication system using a UAV node, comprising:
a memory storing at least one command; and
a processor connected to the memory to execute the at least one command,
wherein the at least one command causes the processor to:
acquire UAV jitter information for the UAV node; and
determine a UAV transmission and reception technique based on the UAV jitter information,
wherein the UAV transmission and reception technique includes determination or configuration of a beamformer or codebook to perform signal transmission and reception robust against a UAV jitter between the UAV node and a counterpart node which is a terrestrial base station or another UAV node.

11. The apparatus according to claim 10, wherein in the acquiring of the UAV jitter information, the at least one command causes the processor to:
receive a jitter reference signal from the counterpart node;
calculate a mean and variance for each azimuth angle measured by an embedded sensor device of the UAV node; and
obtain the UAV jitter information based on a unit vector derived from the jitter reference signal and the calculated mean and variance.

12. The apparatus according to claim 11, wherein the jitter reference signal includes information on an index of a transmission (Tx) beam operated by the counterpart node, which is a terrestrial base station, and includes information related to an angle of departure (AoD) from the counterpart node.

13. The apparatus according to claim 10, wherein in the acquiring of the UAV jitter information, the at least one command causes the processor to:
receive pilot signals from the counterpart node;
calculate a mean and variance for each azimuth angle measured by an embedded sensor device of the UAV node; and
obtain the UAV jitter information based on the mean and variance and information on angles of arrival (AoAs) calculated from information derived from the pilot signals.

14. The apparatus according to claim 10, wherein the at least one command further causes the processor to:
transmit the UAV jitter information to the counterpart node, and
receive information on a reception beamformer for the UAV node from the counterpart node, the reception beamformer being determined by the counterpart node based on the UAV jitter information.

15. The apparatus according to claim 10, wherein the at least one command further causes the processor to:
transmit the UAV jitter information to the counterpart node; and
receive information on a reception beam codebook for the UAV node from the counterpart node, the reception beam codebook being determined by the counterpart node based on the UAV jitter information.

16. The apparatus according to claim 15, wherein the information on the reception beam codebook includes information on a codebook determined by the counterpart node based on the UAV jitter information obtained using a jitter reference signal and a unit vector calculated by the counterpart node.

17. The apparatus according to claim 16, wherein the jitter reference signal includes information on a change in an azimuth angle of the UAV node, angle of arrival (AoA) information of the UAV node, and information on a relative positional relationship from the counterpart node to the UAV node.
